(19) United States
(12) Patent Application Publication
(10) Pub. No.: US 2015/0324813 A1
(43) Pub. Date: Nov. 12, 2015

(54) SYSTEM AND METHOD FOR DETERMINING BY AN EXTERNAL ENTITY THE HUMAN HIERARCHIAL STRUCTURE OF AN RGANIZATION, USING PUBLIC SOCIAL NETWORKS

(71) Applicant: B.G. NEGEV TECHNOLOGIES AND APPLICATIONS LTD., Beer Sheva (IL)

(72) Inventors: Michael Fire, Netanya (IL); Yuval Elovici, D.N.Lachish (IL); Rami Puzis, Ashdod (IL)

(21) Appl. No.: 14/650,446

(22) PCT Filed: Dec. 9, 2013
(86) PCT No.: PCT/IL2013/051011

§ 371 Date: Jun. 8, 2015

(30) Foreign Application Priority Data
Dec. 10, 2012 (IL) 223544

(51) Int. Cl. G06Q 30/02; G06Q 50/00; G06Q 10/10

(52) U.S. Cl. CPC G06Q 30/0201; G06Q 10/105; G06Q 50/01

(57) ABSTRACT

The present invention relates to a method for determining the hierarchical structure of an organization, using data from a social network, for example, Facebook. The method is partially indirect, as it includes some determinations with respect to the departmental division of the organization as well as determination of leadership personnel that are not explicitly indicated anywhere in the social network. The method of the invention is mainly based on analyzing the connections between people, or more particularly the method is based on analysis of “friends” lists of persons within Facebook (or another social network).

### FIELD OF THE INVENTION

The field of the invention relates in general to extraction of information from public social networks. More particularly, the invention relates to a method and system for determining by a third party a human hierarchical structure of an organization, based on information which is publicly provided by a social network.

### BACKGROUND OF THE INVENTION

In recent years, online social networks have grown in scale and variability and today offer individuals the possibility of publicly presenting themselves, exchanging ideas with friends or colleagues, and networking in a scale and manner which was impossible a few years ago. For example, Facebook has more than billion registered users, with many new users signing up each month. According to recent statistics published by Facebook, 50% of Facebook users log onto this site on a daily basis, with an average total time of more than 7 hours per month and more than 30 billion pieces of content shared each month (web links, news stories, blog posts, notes, photo albums, etc.). On one hand, social networks created new opportunities to develop friendships, share ideas, and conduct business. However, on the other hand, many social network users expose via their profile pages personal and community details that relate, among others, to their social connections, and their place of employment. Sometimes, sensitive business data is also unintentionally exposed.

The art has shown that it is possible to extract a network (members, connections between people, etc.) from data available at a social networking service (e.g., Facebook, Twitter, Linkedin, etc.). This can be done, for example, by extracting the connections between various members, starting from a single member, and expanding the structure until determination of the entire network. The time when to stop the “extraction” of the network may be predefined by size, by characteristics of the network members, etc. Said network can be clustered to social communities.

There are various cases in which there is a need for a third party to determine the human structure of a commercial organization without receiving assistance from the organization itself, or from any of its employees. By “organization” it is meant herein to an hierarchical body which employs workers. By “structure of the organization” it is meant to the division of the organization into departments, and to the hierarchical structure of the organization in a whole, as well as in each of its departments, and the leading personnel in each department. There may be various reasons for such a need, such as commercial, financial, intelligence, human resourcing purposes, etc. In many cases, structural data of organizations is not publicly available. In other cases, a few pieces of data are available for an organization, not enabling the construction of the complete structure. The term “complete structure” refers herein to the whole structure of an organization, to the departmental division of the organization, or to a structure of one or more departments within the organization.

The data which the art is able to extract from publicly available social networks is, however, insufficient to determine the structure of a commercial organization. The extraction of a community structure by the prior art, however, fell short of determining of a departmental and human structure of organizations using data extracted from publicly available social network. Moreover, the art fell short of determining the hierarchy and leadership structure of organizations, using said data.

A user in Facebook is requested to provide some of his bibliographic data, such as his name, gender, place of living, educational data, hobbies, etc. In a particular relevancy to the present invention, the user also has the option of indicating his present working place, as well as previous ones. In another aspect, Facebook allows a user to search the database by keywords. For example, if a user types the keywords “Elite Inc.”, he receives access to the web page of this company in Facebook. However, in a vast majority of the cases, this will not lead to the structure of the company. In LinkedIn, typing the word “Elite Inc.” may provide a list of workers in this company, however, in general anything with respect to the structural data of this company is missing, unless specifically listed. Construction of a human structure of an organization (such as a company, corporation, etc.) may sometimes be possible based on data available from social networks. However, this structural construction can typically be performed only when the relevant data is directly available, and it may typically require a significant amount of manual lengthy work.

Various limitations are applied by social networks on searching their databases. For example, upon typing in LinkedIn the word “IBM”, only a limited list of the IBM workers is provided (for example 300 workers), which does not enable construction of the complete structure of this corporation. In another example, Facebook allows carrying out two operations with respect to each person in its database: (a) extraction of the profile page with personal details for that person; and (b) asking for all the friends of that person. However, Facebook throttles massive crawling attempts by limiting the number of operations performed by a single account or from a single IP address. As will be shown, the present invention can operate even under such limitations.

It is therefore an object of the present invention to provide a method and system for constructing a human structure of an organization based on data which is publicly available from a social network.

It is another object of the present invention to provide such a method which overcomes search limitations that are typically applied by social networks.

It is still another object of the present invention to provide a method which applies indirect tools, for overcoming lack of structural data with respect to departmental structure and leadership positions.

It is still another object of the present invention to provide such a method which can be almost entirely automated.

Other objects and advantages of the invention will become apparent as the description proceeds.

### SUMMARY OF THE INVENTION

The invention relates to a method for determining by a third party a structure of a commercial organization based on data extracted from one or more of public social networks, which comprises the steps of: (a) determining the list of employees in the organization by: (a.1) defining a list of employees, and adding few names of known employees to said list; (a.2) defining a list of potential employees; (a.3) extracting from a public social network the list of friends of each of the employees already in said list of employees, and adding the names in all said friend's lists to said list of potential employees; (a.4) for each of the names in said list of potential employees, checking whether they are connected in the public social network with one or more of the names already in said list of employees, and sorting said list of potential employees such that those names having more of such connections appear at the top of the list; (a.5) for each of those names appearing at the top of the list of potential employees, checking at their bibliography whether they work in the organization, and if so, adding to said list of employees, or otherwise dropping from said list of potential employees; (a.6) extracting list of friends from one or more of said newly added names to the list of employees, and repeating the procedure from step a4 above; and (a.7) continuing with the procedure until some threshold is met, thereby completing said list of employees; (b) producing from said list of employees a network representation based on the connections between the various employees; (c) dividing said network representation to a departmental structure, using a community detection algorithm, and assigning a role to each of said departments by checking bibliographies of members in each department and finding a common denominator for the members in each department; and (d) determining leadership positions within the organization by use of centrality measures.

Preferably, said community detection algorithm is a Girvan-Newman fast greedy algorithm.

Preferably, said centrality measures are selected from eigenvector centrality, page rank, closeness, HITS, betweenness, or communicability centrality.

Preferably, said threshold is selected from: (a) a specific number of names that are sequentially checked in said list of potential employees, but none of them is found to work in the organization; (b) a specific number of employees that have been determined and included in said list of employees; (c) when the list of potential employees is empty.

### BRIEF DESCRIPTION OF THE DRAWINGS

In the drawings:

FIG. 1 generally illustrates the invention in a flow diagram form;

FIG. 2 illustrates in a flow diagram form the manner by which a list of employees in an organization is formed, based on data extracted from a social network; and

FIG. 3 shows an exemplary network representation as formed based on data extracted from a public social network, while from said social network a departmental structure and leadership positions can be determined according to the present invention.

### DETAILED DESCRIPTION OF EMBODIMENTS OF THE INVENTION

As noted above, the present invention relates to a method for determining the hierarchical structure of an organization, using data from a social network, for example, Facebook. The method is partially indirect, as it includes some determinations with respect to the departmental division of the organization as well as determination of leadership personnel that are not explicitly indicated anywhere in the social network. As will be shown, the method of the invention is mainly based on analyzing the connections between people, or more particularly the method is based on analysis of “friends” lists of persons within Facebook (or another social network).

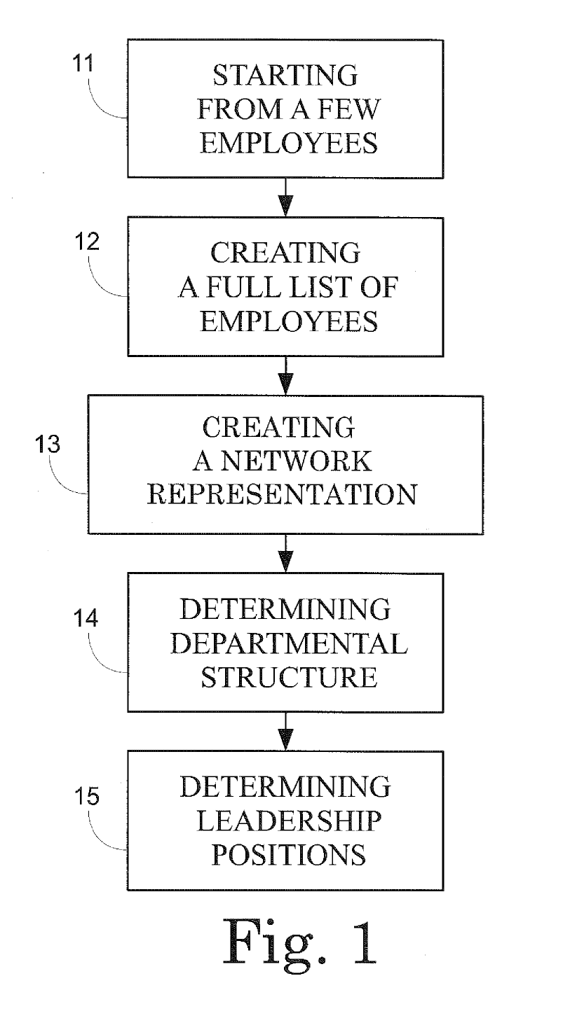

FIG. 1 generally describes the main stages of the method of the invention. The method begins at stage 11, where an initial list of few (one or more) employees of the organization is determined or is obtained by any conventional means. Next, continuing from said initial list of few people, the method creates in stage 12 a full list of employees in the organization using, among others, of “friends” lists that are associated with employees of the organization. More specifically, this stage uses “friends” lists of those employees that are included in said initial list, and then using “friends” lists of employees that are later added to said list of employees. Said stage of 12 of creation of the list of employees will be described in more detail hereinafter. Next, in stage 13 the method creates a network representation defining the networking connections between the employees of the organization, as included in said full list of employees. In stage 14, the method continues by determining from said network representation the departmental structure of the organization, and in stage 15 the method determines those persons that hold leadership positions in the organization, and even more specifically, those persons who hold leadership positions in each of the organization departments.

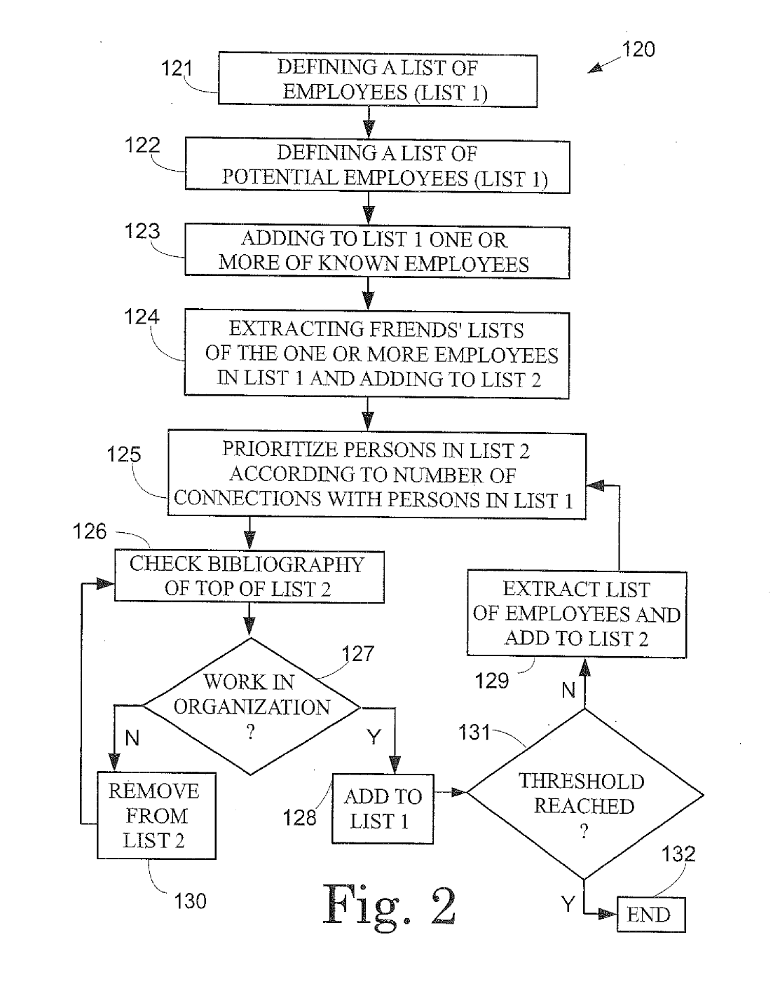

The creation of the list of employees of the organization will now be described in more detail, with respect to FIG. 2. Initially, in step 121 a list of employees (hereinafter, “list 1”) is defined. Next, in step 122 a list of potential employees (hereinafter, “list 2”) is also defined. In step 123, one or more (typically few, for example, two or three but can be somewhat more) of employees known to work in the organization are added to list 1. In step 123, the “friends” lists of those few employees that have been just added to list 1 are extracted from the social network in a known manner, and added to list 2. At this stage, list 1 contains a few employees, and list 2 contains typically several hundreds, or up to tens of thousands or hundreds of thousands of people, hereinafter “potential employees” (i.e., people that should be verified whether they are employees or not). In step 125, list 2 is prioritized, based on the number of friends in list 1. More specifically, for each of the persons now existing in list 2, his list of friends is checked, and the number of his friends existing in list 1 is counted. Clearly, at this stage all the persons in list 2 have at least one friend in list 1, several of them have two or more friends in list 1, and these are pushed to the top of list 2 which is sorted accordingly. Next, in step 126 the bibliography of the person at the top of list 2 is checked, and in step 127 it is verified whether he works in the organization. If it is found in step 127 that he works in the organization, he is added in step 128 to list 1, his list of friends is extracted in step 129, this list of friends is also added to list 2, and the procedure returns to step 125. If, on the other hand, it is found in step 127 that the person does not work in the organization, his name is removed in step 130 from list 2, and this name will also be ignored in the future, if for any reason will come again to be added to list 2. The procedure is then returns to step 126, to check the bibliography of the next person appearing at the top of list 2. The procedure 120 continuous until some type of threshold is reached in step 131, and when this threshold is reached, the procedure ends in step 132. Various types of thresholds may be defined for step 131. For example, the threshold may be 1000 of persons that are sequentially checked in step 127, but none of them is found to work in the organization. In another alternative, threshold 131 may be a specific number of employees that have been found. In still another alternative, the procedure may stop when list 2 is empty.

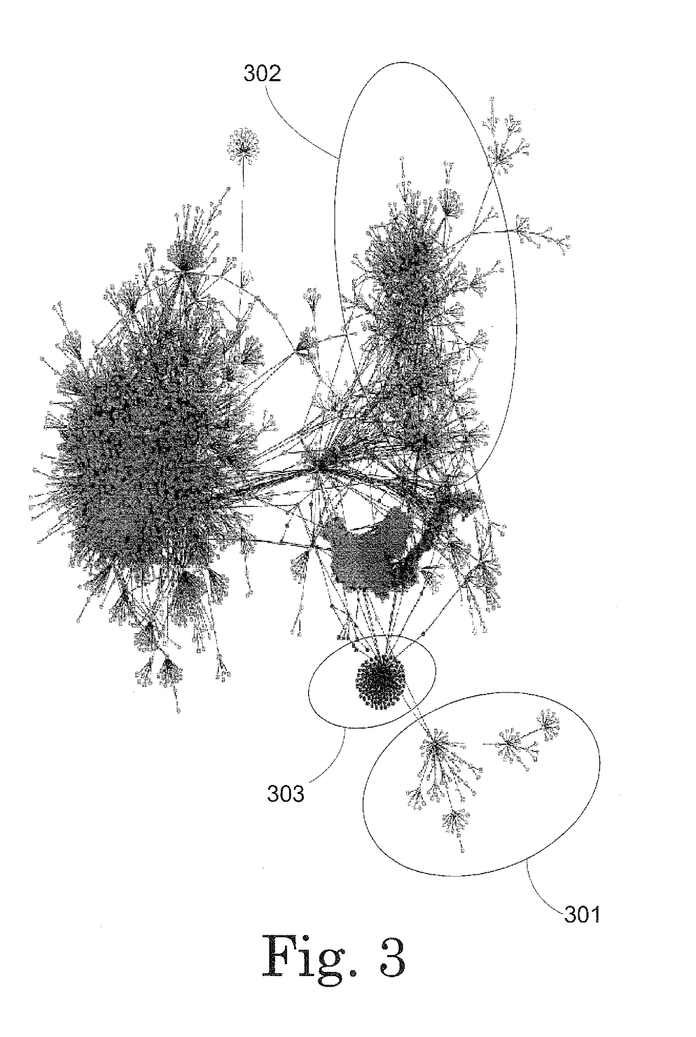

When list 1 has been formed, the network between the given workers in this list is also available or can easily be extracted (step 13 of FIG. 1). An exemplary network representation is shown in FIG. 3.

In the next step (14 in FIG. 1), the invention finds the departmental structure of the organization, given said network between the workers. By “departmental” structure it is meant, for example, to the company departments, branches, acquired companies, divisions, etc. This step may be implemented using a community detection algorithm. Various such algorithms are known in the art, for example, Girvan-Newman fast greedy algorithm. Using such algorithm, step 14 of the procedure first separates the network nodes into a set of disjoint communities. A “community” in the network representation is a set of nodes such that the number of connections within the community is significantly larger that the number of connections from members in the set to non-members. As mentioned, Girvan-Newman algorithm is capable of finding such communities with such a network. In FIG. 3, three exemplary communities 301, 302, and 303 are marked, while the network still comprises additional unmarked communities.

After separating the social network of the organization into disjoint communities, step 14 continues by analyzing the role of each of the detected communities of the organization. This task can be performed, for example, by retrieving position descriptions and location of residence from social network (such as Facebook) profile pages of several community members, until the common denominator of all the community members is determined. For example, the procedure of step 14 may randomly pick up several dozens of users from a community. For these users, the procedure inspects users' positions within the organization by using publicly available professional networking resources, such as LinkedIn. In such a manner, each of said communities is assigned with a respective role.

### EXAMPLE 1

Corporation 1 is an international IT Corporation which provides products and services to customers around the world. According to the company's web page, the company currently employs more than 50,000 employees. An organization crawler was used in step 12 of FIG. 1 as described in more detail with respect to FIG. 2 to collect data on the Corporation 1 employees in South and North America, Asia, Eastern Europe, and Asia. The crawling process was terminated after discovering 45,266 informal links between 5,793 Facebook users who, according to their Facebook profile page, worked in the corporation. The procedure also succeeded in collecting information on the company positions of 1,619 employees. Out of 1,619 employees, the procedure succeeded in identifying 463 holding management positions (step 15 of FIG. 1) in a manner which will be described in more detail hereinafter. A wide range of departments was identified in different parts of the globe: Senior management positions, sales and pricing positions, marketing positions, developers, IT, PM, support engineers, technical writers, etc. Using the community detection algorithm, the inventors separated the Corporation 1 social network into 21 communities. Fourteen of these communities represented nine different roles inside the organization. By examining only the residence and position information of these communities, the inventors pinpointed (1) the group of support engineers in South America; (2) The company's Marketing and Sales division in Eastern Europe; (3) The cooperation's R&D division in North America and East Asia; (4) a part of the North American Management and Sales group. Finally, the inventors discovered that (5) a part of the company's R&D group is located in the Middle East.

After determination of the various communities in the organization, and the role of each community in the network the procedure continues to step 15 of FIG. 1, i.e., to the determination of the individual leadership roles within the organization. The determination of the leadership roles within the organization is based on centrality measures, such as, eigenvector centrality, page rank, closeness, HITS, betweenness, communicability centrality, etc.

The procedure of step 15 analyzes the organizational network representation created in step 13. Let G=<V,E> be the network representation, where ∈ node v∈V is a Facebook user who is associated with the target organization and (u,v)∈E represents a Facebook friendship link between two users. It is possible to pinpoint leadership roles by analyzing solely the structure of G. First, for each user v∈V in G, the procedure calculates several centrality measures. Next, for each centrality measure, the procedure determines the top users (for example, 10 to 20) who received the maximal score. This role determination may be verified from each of said user's bibliography (profile) in Facebook. If the information in one public social network is not enough to reveal the users leadership positions within the organization the leadership positions may be verified from other online sources, such as LinkedIn and Google search engines. By using these methods, the inventors have found that they succeeded in most cases, to accurately reveal the users leadership positions.

Based on said centrality measures, and verification results machine learning algorithms may be used to build classifiers that can automatically identify management roles inside an organization based on the different centrality measures of the vertices in the network representation. By using these classifiers, it is possible to find a wider range of management roles relying on complex centrality measures criteria.

Furthermore, similar means may be used to reveal different statistics about the organization. For example, using said means, the inventors could estimate the percent of management positions and the number of employees inside several organization.

### EXAMPLE 2

Table 1 illustrates the verification of the leadership identification procedure for the top 10 and top 20 employees as identified, using the various centrality measures. The results indicate that each of the calculated centrality measures can assist in identifying managers within an organization. The table shows this verification as done for two small organizations S1 and S2, two medium size organizations M1 and M2, and two large scale corporations L1 and L2. The various centrality measures that have been used are listed in the top row, and are as follows: closeness centrality (Closeness), Betweenness (BC), eigvector centrality (EC), HITS, PageRank, Communicability Centrality (CC), and Load Centrality (LC). Closeness demonstrated the highest average precision at 20 (0.78), while PageRank received the lowest score (0.7).

TABLE 1

| Org. | Category | Degree | Closeness | BC | Hits | PageRank | EC | CC | LC |
|---|---|---|---|---|---|---|---|---|---|
| S1 | Top 10 | 0.5 | 0.4 | 0.6 | 0.3 | 0.5 | 0.3 | 0.3 | 0.6 |
| | Top 20 | 0.35 | 0.3 | 0.3 | 0.3 | 0.25 | 0.3 | 0.3 | 0.3 |
| S2 | Top 10 | 0.8 | 0.9 | 0.8 | 0.9 | 0.7 | 0.9 | 0.9 | 0.8 |
| | Top 20 | 0.7 | 0.75 | 0.75 | 0.7 | 0.75 | 0.7 | 0.75 | 0.75 |
| M1 | Top 10 | 1 | 1 | 0.8 | 1 | 1 | 1 | 1 | 0.8 |
| | Top 20 | 1 | 0.95 | 0.85 | 1 | 0.85 | 1 | 1 | 0.85 |
| M2 | Top 10 | 0.83 | 0.71 | 0.86 | 0.83 | 0.86 | 0.83 | 0.83 | 0.88 |
| | Top 20 | 0.73 | 0.82 | 0.69 | 0.8 | 0.71 | 0.8 | 0.8 | 0.69 |
| L1 | Top 10 | 0.55 | 0.8 | 0.8 | 0.78 | 0.6 | 0.78 | 0.78 | 0.8 |
| | Top 20 | 0.65 | 0.75 | 0.7 | 0.56 | 0.65 | 0.56 | 0.56 | 0.7 |
| L2 | Top 10 | 1 | 1 | 1 | 1 | 1 | 1 | 1 | 1 |
| | Top 20 | 0.92 | 1 | 1 | 1 | 1 | 1 | 1 | 1 |
| Average | Top 10 | 0.78 | 0.8 | 0.81 | 0.8 | 0.78 | 0.8 | 0.8 | 0.81 |
| | Top 20 | 0.725 | 0.76 | 0.715 | 0.73 | 0.7 | 0.73 | 0.735 | 0.715 |

As illustrated above, the above results show that high centrality within a network representation of an organization is a good indication of a leadership role within the organization.

As demonstrated, the invention provides a method which enables a third party (i.e., a person which is external of the organization) to construct a structure of the organization in terms of names of employees, departmental structure, and leadership positions, using public social networks. The method of the invention overcomes typical limitations that are introduced by public social networks in terms of extraction of data from their databases, and shows that performance of this construction is feasible.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Method for determining by a third party a structure of a commercial organization based on data extracted from one or more of public social networks, which comprises the steps of:
a. determining the list of employees in the organization by:
a1. defining a list of employees, and adding few names of known employees to said list;
a2. defining a list of potential employees;
a3. extracting from a public social network the list of friends of each of the employees already in said list of employees, and adding the names in all said friend's lists to said list of potential employees;
a4. for each of the names in said list of potential employees, checking whether they are connected in the public social network with one or more of the names already in said list of employees, and sorting said list of potential employees such that those names having more of such connections appear at the top of the list;
a5. for each of those names appearing at the top of the list of potential employees, checking at their bibliography whether they work in the organization, and if so, adding to said list of employees, or otherwise dropping from said list of potential employees;
a6. extracting list of friends from one or more of said newly added names to the list of employees, and repeating the procedure from step a4 above; and
a7. continuing with the procedure until some threshold is met, thereby completing said list of employees;
b. producing from said list of employees a network representation based on the connections between the various employees;
c. dividing said network representation to a departmental structure, using a community detection algorithm, and assigning a role to each of said departments by checking bibliographies of members in each department and finding a common denominator for the members in each department; and
d. determining leadership positions within the organization by use of centrality measures.

2. The method according to claim 1, wherein said community detection algorithm is selected from Girvan-Newman fast greedy algorithm, Louvian, and MCL.

3. The method according to claim 1, wherein said centrality measures are selected from eigenvector centrality, page rank, closeness, HITS, betweenness, or communicability centrality.

4. The method according to claim 1, wherein said threshold is selected from:
a. A specific number of names that are sequentially checked in said list of potential employees, but none of them is found to work in the organization;
b. a specific number of employees that have been determined and included in said list of employees;
c. when the list of potential employees is empty.
